(19) United States
(12) Patent Application Publication
(10) Pub. No.: US 2008/0164818 A1
(43) Pub. Date: Jul. 10, 2008

(54) DISCHARGE LAMP LIGHTING CIRCUIT

(75) Inventors: Tomoyuki Ichikawa, Shizuoka (JP); Kotaro Matsui, Shizuoka (JP); Yusuke Kasaba, Shizuoka (JP)

Correspondence Address: FISH & RICHARDSON P.C., P.O. BOX 1022, MINNEAPOLIS, MN, 55440-1022, US

(73) Assignee: Koito Manufacturing Co., Ltd., Tokyo (JP)

(21) Appl. No.: 11/970,059

(22) Filed: Jan. 7, 2008

(30) Foreign Application Priority Data
Jan. 10, 2007 (JP) 2007-002624

(51) Int. Cl. B60Q 1/14; H05B 37/02

(52) U.S. Cl. 315/77; 315/225

(57) ABSTRACT

A discharge lamp lighting circuit includes a power supplying portion having a half bridge inverter for converting an output of a DC power supply into AC power, and a bridge driver for driving the half bridge inverter, and a control portion for generating a control signal S₁ to control a driving frequency F of the bridge driver. The control portion has a random number generating circuit for generating a random number signal and changes the driving frequency F in accordance with the random number signal at a time interval of N/F, wherein N is an integer of one or more.

### RELATED APPLICATION(S)

This application claims priority from Japanese Application No. JP2007-002624, filed on Jan. 10, 2007. The contents of the Japanese application are incorporated herein by reference.

### TECHNICAL FIELD

The present disclosure relates to a discharge lamp lighting circuit.

### BACKGROUND ART

In order to light a discharge lamp such as a metal halide lamp to be used for a headlamp of a vehicle, a lighting circuit (a ballast) for stably supplying a power is required. For example, a discharge lamp lighting circuit disclosed in Japanese Patent Document JP-A-2006-72817 comprises a DC-AC converting circuit including a half bridge inverter. An AC power is supplied from the DC-AC converting circuit to the discharge lamp. The magnitude of the supplied power is controlled by changing a driving frequency of the half bridge inverter.

In some cases in which the discharge lamp is lighted at a high frequency, a phenomenon occurs in which an air pressure in the discharge lamp and a lighting frequency are resonated at a frequency determined by a shape of a discharge tube or a sound velocity in the discharge tube (which will be hereinafter referred to as an acoustic resonance phenomenon) so that a light distribution of the discharge lamp is disturbed or the discharge lamp is extinguished at that time. In the conventional discharge lamp lighting circuit in the headlamp for a car, in the case in which the discharge lamp is driven at a high frequency in a shape of a sine wave, a driving frequency is defined on the order of megahertz so as to avoid acoustic resonance of the discharge lamp.

However, a frequency at which the acoustic resonance phenomenon is generated in the discharge lamp (which will be hereinafter referred to as an acoustic resonance frequency) fluctuates before a transition to stationary lighting immediately after a lighting operation of the discharge lamp is started. For this reason, it is difficult, if not impossible, to obtain a stable arc discharge by defining a frequency range of a driving frequency in some cases. More specifically, there is a possibility that the acoustic resonance frequency might be shifted to a high frequency because of low air pressure in the discharge tube immediately after a starting operation of the discharge lamp. The acoustic resonance phenomenon might also be generated immediately after the starting operation at a frequency at which the acoustic resonance phenomenon is not generated at time of stationary lighting.

### SUMMARY

Aspects of the invention are set forth in the claims.

The invention has been made in view of the foregoing problems.

In order to solve the problems discussed above, the disclosure provides a discharge lamp lighting circuit for supplying, to a discharge lamp, an AC power to light the discharge lamp. The circuit includes a power supplying portion having an inverter circuit for converting an output of a DC power supply into the AC power and a driving circuit for driving the inverter circuit. The circuit also has a control portion for generating a control signal to control a driving frequency F of the driving circuit. The control portion has a random number generating circuit for generating a random number signal and changing the driving frequency F by a variation in accordance with the random number signal at a time interval of N/F (N is an integer of one or more).

The inverter circuit of the power supplying portion is driven at the driving frequency F Consequently, DC power is converted into AC power, which is supplied to the discharge lamp. The driving frequency F is controlled in response to a control signal generated by the control portion and the driving frequency F is changed in accordance with a random number signal which has a small regularity and is generated at the time interval of N/F. Consequently, the driving frequency of the inverter circuit can be set to be a different frequency in compression waves generated in a discharge tube of the discharge lamp. Therefore, it is possible to reduce an acoustic resonance phenomenon from a lighting starting operation of the discharge lamp to stationary lighting. As a result, it is possible to prevent extinction of the discharge lamp in the lighting starting operation or a disturbance of the light distribution.

It is preferable that the control portion generate the random number signal to have a periodicity in a cycle that is longer than the time interval for a cycle of a change in the driving frequency F and that is longer than an inverse number of an acoustic resonance frequency of the discharge lamp.

In this case, power supplied to the discharge lamp in a generation cycle of the random number signal is averaged so that power supplied at an optional time is specified. Therefore, it is possible easily to control the power supplied to the discharge lamp. In addition, by setting the generation cycle of the random number signal to be greater than the inverse number of the acoustic resonance frequency, it is possible to prevent acoustic resonance phenomenon in the discharge lamp more reliably.

It also is preferable that the random number generating circuit include a shift register and an exclusive OR gate and serve to generate, as the random number signal, an M sequence having a periodicity determined by the number of digits of the shift register.

By employing the foregoing structure, it is possible to implement control of the driving frequency through a comparatively small-sized circuit including the shift register and the exclusive OR gate.

Furthermore, it is also preferable that the control portion change the driving frequency F by a variation in accordance with the random number signal in a predetermined time zone at the start of a lighting operation of the discharge lamp.

Immediately after the lighting starting operation of the discharge lamp, air pressure in the discharge lamp is low and the discharge is unstable. The acoustic resonance phenomenon easily is caused at a lighting frequency on the order of megahertz. By controlling a change in the driving frequency in a predetermined time zone in the lighting starting operation, it is possible to carry out a transition to an arc discharge in a stable manner.

Moreover, it is preferable that the control portion have a first current source for generating a first current corresponding to a difference between a power supplied to the discharge lamp and a target power, a second current source connected to the random number generating circuit and serving to generate a second current having a magnitude corresponding to the random number signal. The control portion also should have a capacitive element connected to outputs of the first current source and the second current source and serving to carry out charging corresponding to the first and second currents. The control portion also has a hysteresis comparator for entering a charging voltage of the capacitive element and providing, as the control signal, a comparison signal generated based on the charging voltage. The control portion includes a switching device connected to both terminals of the capacitive element and turned ON/OFF in response to an output of the hysteresis comparator.

With this structure, the capacitive element is charged with the first current (determined by the difference between the target power and the power supplied to the discharge lamp) and the second current (determined by the random number signal). A rectangular wave of a frequency corresponding to a charging speed of the capacitive element is provided as a control signal for driving the inverter circuit through the hysteresis comparator and the switching device. With a comparatively simple circuit structure, thus, it is possible to reduce the acoustic resonance phenomenon from the lighting starting operation of the discharge lamp to the stationary lighting.

It also is possible to enhance the stability from a lighting starting operation of a discharge lamp to stationary lighting.

A preferred embodiment of a discharge lamp lighting circuit is described below in detail with reference to the drawings. In the explanation of the drawings, the same or corresponding portions have the same reference numerals and repetitive description will be omitted. Various features and advantages will be apparent from the description, the drawings and the claims.

### BRIEF DESCRIPTION OF THE DRAWINGS

FIG. 1 is a block diagram showing a structure of a discharge lamp lighting circuit 1 according to a preferred embodiment of the invention,

FIG. 2 is a graph showing an example of a relationship between a driving frequency of a discharge lamp and a degree of an acoustic resonance phenomenon in FIG. 1,

FIG. 3 is a graph showing a temporal variation in various signals generated in a control portion of FIG. 1, (a) showing a charging voltage of a capacitor, (b) showing a comparison signal generated by a hysteresis comparator in FIG. 1, (c) showing a control signal generated by a toggle flip-flop in FIG. 1, and (d) showing an output signal of a divider in FIG. 1,

FIG. 4 is a circuit diagram showing a structure of a random number generating circuit in FIG. 1, and

FIG. 5(a) is a diagram showing a waveform of an input current of a discharge lamp L, FIG. 5(b) is a diagram showing a waveform of the input current of the discharge lamp L in the case in which a time interval of a change control of a driving frequency is changed, and FIG. 5(c) is a diagram showing a waveform of the input current of the discharge lamp L in the case in which the time interval of the change control of the driving frequency is made random.

### DETAILED DESCRIPTION

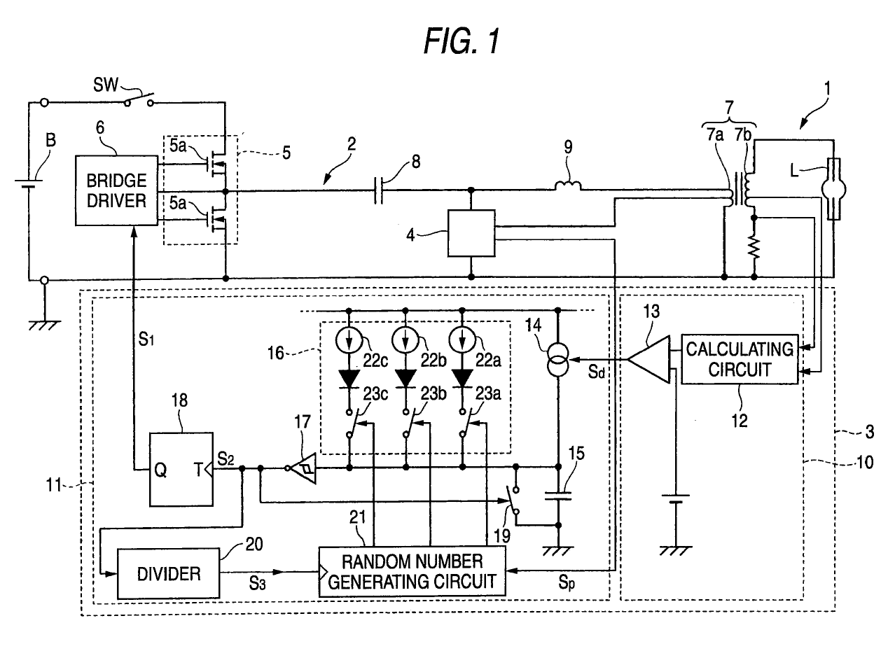

FIG. 1 is a block diagram showing a structure of a discharge lamp lighting circuit 1 according to a preferred embodiment of the invention. The discharge lamp lighting circuit 1 shown in FIG. 1 serves to supply an AC power for lighting a discharge lamp L. The circuit converts a DC voltage applied from a DC power supply B to an AC voltage and supplies the AC voltage to the discharge lamp L. The discharge lamp lighting circuit 1 can be used for a lighting device such as a headlamp for a vehicle. Although a mercury free metal halide lamp is suitable for the discharge lamp L, for example, other types of discharge lamps may be used.

The discharge lamp lighting circuit 1 comprises a power supplying portion 2 for supplying AC power to the discharge lamp L upon receipt of a supply of a power from the DC power supply B, and a control portion 3 for controlling the magnitude of power supplied to the discharge lamp L.

The power supplying portion 2 converts DC power into AC power at a driving frequency based on a control signal S₁ sent from the control portion 3, and supplies the AC power to the discharge lamp L. The power supplying portion 2 is connected to the DC power supply B, such as a DC battery, and carries out a conversion into AC and raises the pressure upon receipt of a DC voltage output from the DC power supply B. The power supplying portion 2 has a starting portion 4 for applying a high pressure pulse to the discharge lamp L at the start of a lighting operation to promote lighting, a half bridge inverter (inverter circuit) 5 having two transistors 5a and 5b as switching devices which are connected in series, and a bridge driver (driving circuit) 6 for driving the half bridge inverter 5 by alternately switching the transistors 5a and 5b. For the transistors 5a and 5b, an N channel MOSFET is suitable as shown in FIG. 1, for example, although other FETs or a bipolar transistor may be used. In the illustrated embodiment, the transistor 5a has a drain terminal connected to a plus side terminal of the DC power supply B through a switch SW for operating the start of the lighting operation, and a source terminal connected to a drain terminal of the transistor 5b and a gate terminal connected to the bridge driver 6. The transistor 5b has a source terminal connected to a ground potential wire (that is, a negative side terminal on the DC power supply B) and a gate terminal connected to the bridge driver 6. The bridge driver 6 supplies driving signals in opposite phases to each other to the gate terminals of the transistors 5a and 5b based on the control signal S₁ to be a PFM signal so that the transistors 5a and 5b alternately conduct. Consequently, the half bridge inverter 5 is operated to convert the DC power into AC power at a driving frequency which is coincident with the frequency of the control signal S₁.

The power supplying portion 2 further has a transformer 7, a capacitor 8 and an inductor 9. The transformer 7 is provided for applying a high pressure pulse to the discharge lamp L, for transmitting the AC power generated in the half bridge inverter 5 and for raising a pressure of the power. In addition, the transformer 7, the capacitor 8 and the inductor 9 constitute a series resonant circuit. More specifically, a primary winding 7a of the transformer 7, the inductor 9 and the capacitor 8 are connected in series to each other. The series circuit has one of its terminals connected to the source terminal of the transistor 5a and the drain terminal of the transistor 5b, and the other terminal connected to the ground potential wire. With this structure, the resonance frequency is determined by a synthetic reactance constituted by the leakage inductance of the primary winding 7a of the transformer 7 and the inductance of the inductor 9, and the capacitance of the capacitor 8. The series resonance circuit may be constituted by only the primary winding 7a and the capacitor 8 and the inductor 9 may be omitted. Furthermore, the inductance of the primary winding 7a may be set to be much smaller than that of the inductor 9 and the resonance frequency may be determined primarily by the inductor 9 and the capacitor 8.

In the power supplying portion 2, the AC power is transmitted from the half bridge inverter 5 to the primary winding 7a of the transformer 7. The AC power is raised in pressure and is transmitted to a secondary winding 7b of the transformer 7, and is supplied to the discharge lamp L connected to both terminals of the second winding 7b. The bridge driver 6 for driving the transistors 5a and 5b reciprocally drives the transistors 5a and 5b such that both of the transistors 5a and 5b are not brought into a conducting state. The power supplied to the discharge lamp L depends on the driving frequency of the half bridge inverter 5. More specifically, the magnitude of the power supplied to the discharge lamp L has a maximum value when the driving frequency is equal to the resonance frequency of the series resonant circuit, and is increased/decreased by a change in the driving frequency. The reason is that an impedance of the series resonant circuit is changed depending on the driving frequencies of the transistors 5a and 5b through the bridge driver 6. Accordingly, it is possible to control the magnitude of the AC power supplied to the discharge lamp L by changing the driving frequency through the control portion 3.

The starting portion 4 serves to apply a high pressure pulse for starting the discharge lamp L and applies a trigger voltage and current (a high voltage pulse) to the primary winding 7a of the transformer 7, thereby superposing the high pressure pulse on the AC voltage generated in the secondary winding 7b of the transformer 7. More specifically, the starting portion 4 includes a starting capacitor for storing power to generate the high pressure pulse and a self-breakdown type switching device (not shown) such as a spark gap or a gas arrester. The starting portion 4 instantaneously brings the switching device of the self-breakdown type into a conducting state to output the trigger voltage and current when the starting capacitor is charged at the start of the lighting operation so that a voltage on both terminals reaches a breakdown voltage. Moreover, the starting portion 4 generates a pulse detection signal S_{P} the moment the trigger voltage and current are generated, and sends the pulse detection signal S_{P} to the control portion 3, which will be described below.

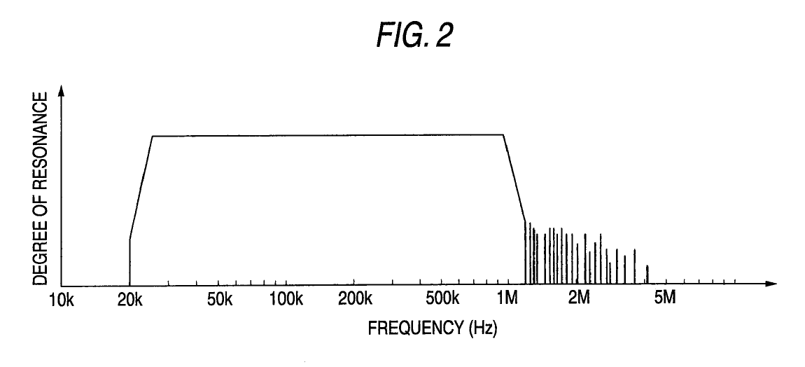

In some cases in which the discharge lamp L is lighted by the power supplying portion 2, there is generated an acoustic resonance phenomenon in which a compression wave of gas in the discharge tube of the discharge lamp L resonates at the driving frequency. The acoustic resonance frequency causing the acoustic resonance phenomenon depends on the shape of the discharge lamp and the air pressure. FIG. 2 is a graph showing an example of a relationship between the driving frequency of the discharge lamp L and the degree of the acoustic resonance phenomenon. As shown in FIG. 2, in the discharge lamp L, the acoustic resonance phenomenon is continuously generated at the driving frequency in a frequency band (a continuous resonance band) of approximately 20 kHz to 1.4 MHz. Moreover, the acoustic resonance phenomenon is intermittently generated in a plurality of small frequency bands in approximately 1.4 MHz to 4 MHz and has a comb-shaped characteristic. The comb-shaped characteristic is caused by an individual difference in a discharging characteristic of the discharge tube in the discharge lamp L. Accordingly, it is assumed that the continuous resonance band is left in order to obtain a stable discharge arc in the discharge lamp L.

The characteristic shown in FIG. 2 is obtained when the discharge lamp L is lighted. On the other hand, immediately after the lighting starting operation of the discharge lamp L is carried out by an application of a high pressure pulse, the air pressure in the discharge tube is comparatively low. In the illustrated characteristic, therefore, the acoustic resonance frequency is shifted rightward. The reason is as follows. After the discharge lamp L is started at cold starting, mercury or metal halide (metal iodide) gradually evaporates. Therefore, the air pressure in the discharge tube is much lower immediately after the starting operation than that in the stationary lighting. Also, when the discharge lamp L is driven at a higher frequency (for example, approximately 2 MHz) than the continuous resonance band in the stationary lighting, there is a possibility that the continuous resonance band might be entered immediately after the starting operation to generate the acoustic resonance phenomenon. As a result, there is a possibility that a stable discharge arc cannot be obtained and an extinction might be caused by the disturbance of the discharge arc.

To avoid the acoustic resonance phenomenon, the driving frequency is controlled by the control portion 3 having the following structure in the discharge lamp lighting circuit 1.

As shown in FIG. 1, the control portion 3 serves to control the driving frequency of the bridge driver 6 and is constituted by an error detecting portion 10 and a V-F (voltage-frequency) converting portion 11.

The error detecting portion 10 includes a calculating circuit 12 and an error amplifier 13. The calculating circuit 12 is connected to the secondary winding 7b of the transformer 7 and serves to detect an input current and an input voltage of the discharge lamp L and to calculate a power supplied to the discharge lamp L. The error amplifier 13 enters a voltage signal corresponding to the supplied power calculated by the calculating circuit 12 and a reference voltage, and generates an error signal S_{d} corresponding to a difference between the supplied power and a target power defined by the reference voltage.

The V-F converting portion 11 changes the driving frequency so that the supplied power approximates the target power based on the error signal S_{d} from the error detecting portion 10 and thus generates the control signal S₁. In detail, the V-F converting portion 11 includes a current source (a first current source) 14, a capacitor (a capacitive element) 15, a current generating circuit (a second current source) 16, a hysteresis comparator 17, a toggle flip-flop 18, a switching device 19, a divider 20 and a random number generating circuit 21.

The current source 14 is connected to an output of the error amplifier 13, and generates a current (a first current) obtained by regulating a current amount based on the error signal S_{d}. More specifically, the current source 14 changes the current amount so that the difference between the power supplied to the discharge lamp L and the target power is reduced. The capacitor 15 has one of its terminals connected to an output of the current source 14 and the other terminal grounded, and a charge is stored (charged) by the current flowing from the current source 14. Moreover, an input of the hysteresis comparator 17 is connected to the terminal of the capacitor 15. The hysteresis comparator 17 has an hysteresis on a threshold voltage, and the charging voltage of the capacitor 15 is compared with two different threshold voltages V_{THL} and V_{THH} to generate a comparison signal S₂. Moreover, an output of the hysteresis comparator 17 is connected to a T input of the toggle flip-flop 18, a control terminal of the switching device 19 and an input of the divider 20. The switching device 19 is connected to both terminals of the capacitor 15 and is turned ON/OFF in response to an output of the hysteresis comparator 17, thereby switching the charge/discharge of the capacitor 15. Consequently, the comparison signal S₂ of the hysteresis comparator 17 is changed into a pulse signal having a frequency corresponding to the current amount in the current source 14. The comparison signal S₂ is shaped into the control signal S₁ having a certain pulse width through the toggle flip-flop 18 and the control signal S₁ is sent from a Q output of the toggle flip-flop 18 to the bridge driver 6.

Outputs of the current generating circuit 16 are connected together to the terminal of the capacitor 15. The current generating circuit 16 includes current sources 22a, 22b and 22c and switching devices 23a, 23b and 23c. The current sources 22a, 22b and 22c and the switching devices 23a, 23b and 23c constitute a series circuit with rectifying devices interposed therebetween, and the outputs of the respective series circuits are connected to the terminal of the capacitor 15. Control terminals of the switching devices 23a, 23b and 23c are connected to an output of the random number generating circuit 21 and are turned ON/OFF in response to a signal corresponding to three bits in a random number signal generated by the random number generating circuit 21 (the details of which are described below). Consequently, the current generating circuit 16 generates a current (a second current) in an amount corresponding to the random number signal and supplies the same current to the capacitor 15. As a result, the capacitor 15 is charged corresponding to a current fed from the current source 14 and a current fed from the current generating circuit 16. Therefore, the control signal S₁ is changed into a pulse signal having a frequency corresponding to a total amount of the currents of the current source 14 and the current generating circuit 16. In order to maintain an irregularity of the driving frequency of the bridge driver 6 based on the random number signal which is generated, it is preferable that the current values of the current sources 22a, 22b and 22c should be set to have different values from each other. In this case, the second current can be generated with eight types of current values in accordance with the random number signal. The current sources 22a, 22b and 22c of the current generating circuit 16 also can be substituted for resistive elements.

The divider 20 multiplies a frequency of the comparison signal S₂ by 1/N (where N is an integer equal to one or more) and sends a clock signal S₃ to the random number generating circuit 21. A dividing ratio of the divider 20 may be fixed or controlled to have a variable value in a time zone before and after the lighting starting operation of the discharge lamp L. In the embodiment, the dividing ratio is set to be 1/2, for example.

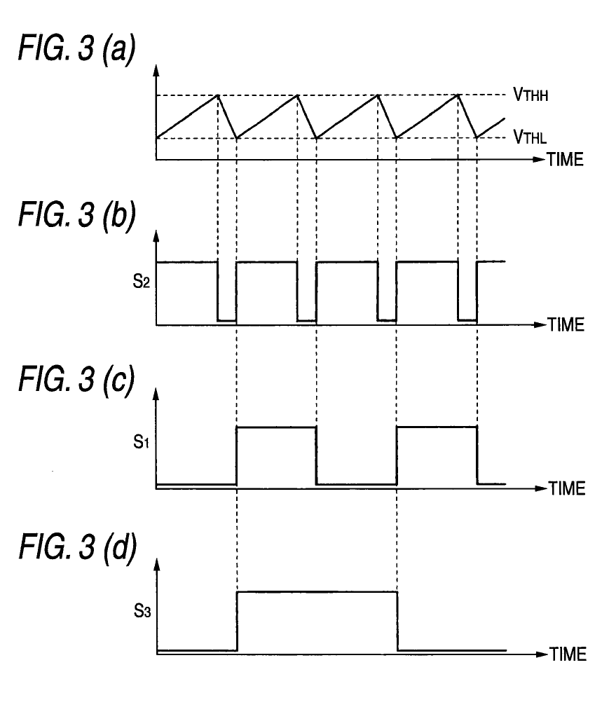

FIG. 3 is a graph showing a temporal variation in various signals generated in the control portion 3. In particular, FIG. 3(a) shows a charging voltage of the capacitor 15, FIG. 3(b) shows the comparison signal S₂, FIG. 3(c) shows the control signal S₁, and FIG. 3(d) shows the signal S₃ output from the divider 20. The control signal S₁ is generated as a PFM signal (a pulse signal) having a frequency corresponding to a total value of the current amount of the current source 14 and that of the current generating circuit 16, and the signal S₃ from the divider 20 is generated as a pulse signal obtained through a division of the frequency of the control signal S₁ by two.

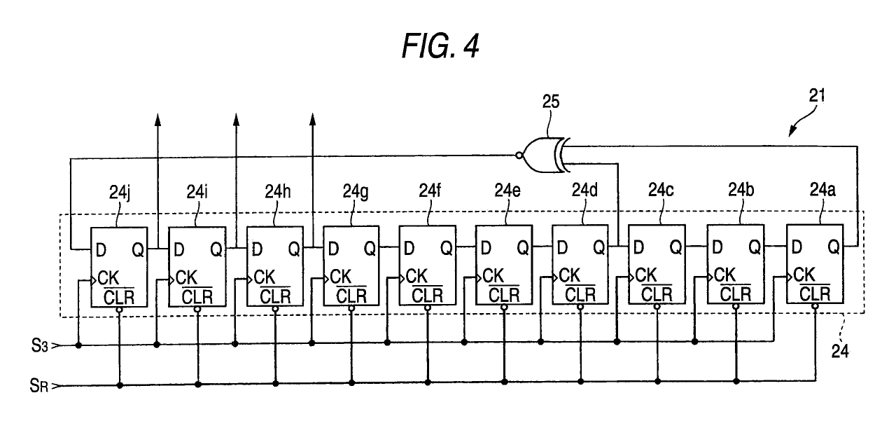

Next, a circuit structure of the random number generating circuit 21 is described in detail with reference to FIG. 4.

As shown in FIG. 4, the random number generating circuit 21 is constituted by a 10-bit shift register 24 obtained by connecting ten D flip-flops 24a to 24j in series, and an exclusive OR (ExOR) gate 25. Q outputs of the D flip-flops 24b to 24j in previous stages are connected to D inputs of the D flip-flops 24a to 24i respectively, and a Q output of the D flip-flop 24a is connected to a D input of the D flip-flop 24j. Moreover, the clock signal S₃ is input from the divider 20 to clock inputs of the respective D flip-flops 24a to 24j, and an initializing signal S_{R} is input to clear inputs of the D flip-flops 24a to 24j at a predetermined time such as the start of the discharge lamp L. The initializing signal S_{R} is generated based on the pulse detection signal S_{P} sent from the starting portion 4. The Q outputs of the D flip-flop 24a and the D flip-flop 24d are connected to an input of the exclusive OR gate 25, and an output of the exclusive OR gate 25 is connected to the D input of the D flip-flop 24j. The input of the exclusive OR gate 25 may be connected to another D flip-flop in accordance with a primitive polynomial for generating an M sequence. The Q outputs of the D flip-flops 24h, 24i and 24j are connected to the control terminals of the switching devices 23a, 23b and 23c, respectively.

The random number generating circuit 21 generates the M sequence to be a random number having a periodicity determined by the number of digits of the shift register 24. More specifically, the random number generating circuit 21, including the 10-digit shift registers 24, generates a 10-bit random number having a periodicity, which is 1023 (=2¹⁰−1) times as great as a clock cycle of the clock signal S₃, every the same clock cycle, and holds the random number in the Q output in the shift register 24. Accordingly, the random number generating circuit 21 generates a 10-bit random number at a time interval of N/F, wherein the current driving frequency of the bridge driver 6 is represented by F and the dividing ratio of the divider 20 is represented by 1/N. When any of the random numbers held by the shift register 24, which corresponds to three bits, is provided as the random number signal to the switching devices 23a, 23b and 23c so that the switching devices 23a, 23b and 23c are turned ON/OFF in response to the random number signal. Consequently, the magnitude of the current generated by the current generating circuit 16 is changed in accordance with the random number signal. As a result, the driving frequency F of the bridge driver 6 also is changed in accordance with the random number signal. Moreover, the cycle of the variation is 1023×N/F which is equal to the cycle of the random number signal.

A generating cycle of the random number signal generated in the random number generating circuit 21 is set to be 1023 times as great as the clock cycle of the clock signal S₃. By changing the number of digits of the shift register 24, it is possible to set various cycles in consideration of a processing load or a circuit scale. On the other hand, the generating cycle of the random number signal should be set to be a sufficiently longer period of time as compared with the time interval N/F of the control of the driving frequency F through the random number signal. In this case, the power supplied to the discharge lamp in the generating cycle of the random number signal is averaged so that the power to be supplied at an optional point is specified. Therefore, it is possible easily to control the power supplied to the discharge lamp in the control portion 3. Moreover, the generating cycle of the random number should be set to be longer than an inverse number of the acoustic resonance frequency of the discharge lamp L so that the driving frequency F is not coincident with the acoustic resonance frequency of the discharge lamp L.

Moreover, the random number generating circuit 21 should control the change of the driving frequency F to generate the random number signal in a predetermined time zone at the start of the lighting operation of the discharge lamp. For example, it is possible to carry out control so as to perform the change control in a predetermined time zone after a certain time from the ON operation of the power switch SW, to carry out control so as to perform the change control for several tens of seconds after detection of the pulse detection signal S_{P} sent from the starting portion 4 or to detect a change control timing from a waveform of an input current or an input voltage in the discharge lamp L. Immediately after the lighting operation of the discharge lamp L is started, the air pressure in the discharge lamp L is low and the discharge is unstable, and the acoustic resonance phenomenon is caused easily at a lighting frequency on the order of megahertz. By carrying out the change control of the driving frequency F in the predetermined time zone at the start of the lighting operation, it is possible to make a transition to the arc discharge in a stable manner.

The function and effect of the discharge lamp lighting circuit 1 is described below.

In the discharge lamp lighting circuit 1, the half bridge inverter 5 of the power supplying portion 2 is driven at the driving frequency F so that the DC power is converted into the AC power, which is supplied to the discharge lamp L. In the conventional lighting circuit, approximately 2 MHz which gets out of the continuous resonance zone is set to be a fundamental frequency, and the driving frequency is subjected to a frequency modulation and thus fluctuates when the acoustic resonance phenomenon is generated in the discharge lamp depending on the value of the driving frequency. However, the characteristic of the acoustic resonance frequency is changed from the time immediately after start of the lighting operation of the discharge lamp to the stationary lighting so that the driving frequency enters the continuous resonance zone immediately after the starting operation and the stable discharge arc cannot be obtained in some cases. On the other hand, in the illustrated embodiment, the driving frequency F is controlled in response to the control signal S₁ generated by the control portion 3 and the driving frequency F is changed in accordance with the random number signal, which has a small regularity and is generated at a time interval of N/F through the control portion 3. By setting the driving frequency of the half bridge inverter 5 to be a different frequency in compression waves generated in the discharge tube of the discharge lamp L, it is possible to change the frequency before a standing wave is formed. As a result, it is possible to reduce the acoustic resonance phenomenon from the start of the lighting operation of the discharge lamp L to the stationary lighting. Thus, it is possible to prevent an extinction or a disturbance of a light distribution at the lighting start in the discharge lamp L.

Also, in the control portion 3, the random number generating means is constituted by the shift register 24 and the exclusive OR gate 25. Therefore, it is possible to implement the control of the driving frequency with a comparatively small-sized circuit.

The invention is not restricted to the embodiment describe above. For example, although the control portion 3 sets the current values of the current sources 22a, 22b and 22c to be constant, thereby setting the range of the driving frequency to be constant, it also is possible to cause the range to be variable by increasing the range immediately after the starting operation of the discharge lamp L. The variable control of the range of the driving frequency can be carried out by causing the current values of the current sources 22a, 22b and 22c to be variable.

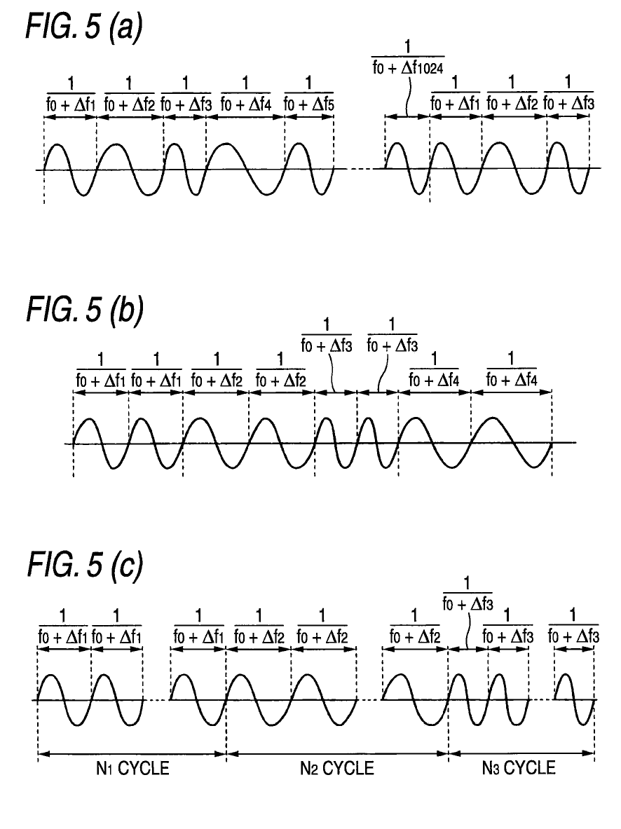

Furthermore, the control portion 3 properly can set the time interval N/F of the change control of the driving frequency by changing the dividing ratio 1/N of the divider 20. FIG. 5(a) shows a waveform of an input current of the discharge lamp L in the case in which the time interval of the change control is 1/F, and FIG. 5(b) shows a waveform of the input current of the discharge lamp L in the case in which the time interval of the change control is 2/F. In the case in which the time interval of the change control is 1/F, a cycle of the input current is changed into 1/(f₀+Δf₁), . . . , 1/(f₀+Δf₁₀₂₄). On the other hand, in the case in which the time interval of the change control is 2/F, two cycles of the input current are changed into 1/(f₀+Δf₁), 1/(f₀+Δf₂), . . . . In the discharge lamp lighting circuit of the series resonant type, in some cases in which the frequency of the half bridge inverter 5 is rapidly changed in respect of the characteristic of the resonant circuit, the lighting frequency is not changed significantly (i.e., the frequency of the input current of the discharge lamp L is not changed). Also in those cases, it is possible to implement the change control at a speed which can correspond to a change in the frequency of the resonant circuit by regulating the time interval of the change control.

Furthermore, in the control portion 3, the dividing ratio 1/N of the divider 20 may be changed based on a random number independent of the random number generating circuit 21 to randomly select the time interval N/F of the change control of the driving frequency. FIG. 5(c) shows a waveform of the input current of the discharge lamp L in this case. In the example, a cycle corresponding to an N₁ cycle of the input current is set to be 1/(f₀+Δf₁) and a subsequent cycle corresponding to an N₂ cycle of the input current is set to be 1/(f₀+Δf₂). Thus, the time interval N/F of the change control is determined by a random number. Even if the characteristic of the discharge lamp L fluctuates, thus, it is possible to avoid the acoustic resonance phenomenon more reliably.

Other implementations are within the scope of the claims

What is claimed is:

1. A discharge lamp lighting circuit for supplying, to a discharge lamp, an AC power to light the discharge lamp, the discharge lamp lighting circuit comprising:
a power supplying portion having an inverter circuit for converting an output of a DC power supply into the AC power and having a driving circuit for driving the inverter circuit; and
a control portion for generating a control signal to control a driving frequency F of the driving circuit,
the control portion having a random number generating circuit for generating a random number signal and for changing the driving frequency F in accordance with the random number signal at a time interval of N/F, wherein N is an integer of one or more.

2. The discharge lamp lighting circuit according to claim 1, wherein the control portion is configured to generate the random number signal to have a periodicity in a cycle which is longer than the time interval of a change in the driving frequency F and is longer than an inverse number of an acoustic resonance frequency of the discharge lamp.

3. The discharge lamp lighting circuit according to claim 1, wherein the random number generating circuit includes a shift register and an exclusive OR gate and is arranged to generate, as the random number signal, an M sequence having a periodicity determined by the number of digits of the shift register.

4. The discharge lamp lighting circuit according to claim 1, wherein the control portion is configured to change the driving frequency F in accordance with the random number signal in a predetermined time zone at a start of a lighting operation of the discharge lamp.

5. The discharge lamp lighting circuit according to claim 1, wherein the control portion further includes:
a first current source for generating a first current corresponding to a difference between a power supplied to the discharge lamp and a target power;
a second current source connected to the random number generating circuit and arranged to generate a second current having a magnitude corresponding to the random number signal;
a capacitive element connected to outputs of the first current source and the second current source and arranged to carry out charging corresponding to the first and second currents;
a hysteresis comparator for providing a charging voltage of the capacitive element and providing, as the control signal, a comparison signal generated based on the charging voltage; and
a switching device connected to both terminals of the capacitive element and arranged to be turned ON/OFF in response to an output of the hysteresis comparator.

6. The discharge lamp lighting circuit according to claim 1, wherein:
the control portion is configured to generate the random number signal to have a periodicity in a cycle which is longer than the time interval of a change in the driving frequency F and is longer than an inverse number of an acoustic resonance frequency of the discharge lamp,
the random number generating circuit includes a shift register and an exclusive OR gate and is arranged to generate, as the random number signal, an M sequence having a periodicity determined by the number of digits of the shift register,
the control portion is arranged to changes the driving frequency F in accordance with the random number signal in a predetermined time zone at a start of a lighting operation of the discharge lamp, the control including:
a first current source for generating a first current corresponding to a difference between a power supplied to the discharge lamp and a target power;
a second current source connected to the random number generating circuit and arranged to generate a second current having a magnitude corresponding to the random number signal;
a capacitive element connected to outputs of the first current source and the second current source and arranged to carry out charging corresponding to the first and second currents;
a hysteresis comparator for providing a charging voltage of the capacitive element and providing, as the control signal, a comparison signal generated based on the charging voltage; and
a switching device connected to both terminals of the capacitive element and arranged to be turned ON/OFF in response to an output of the hysteresis comparator.

7. A lighting device for a vehicle, comprising;
a discharge lamp lighting circuit for supplying, to a discharge lamp, an AC power to light the discharge lamp,
the discharge lamp lighting circuit comprising:
a power supplying portion having an inverter circuit for converting an output of a DC power supply into the AC power and having a driving circuit for driving the inverter circuit; and
a control portion for generating a control signal to control a driving frequency F of the driving circuit,
the control portion having a random number generating circuit for generating a random number signal and for changing the driving frequency F in accordance with the random number signal at a time interval of N/F, wherein N is an integer of one or more,
wherein the control portion is configured to generate the random number signal to have a periodicity in a cycle which is longer than the time interval of a change in the driving frequency F and is longer than an inverse number of an acoustic resonance frequency of the discharge lamp,
wherein the random number generating circuit includes a shift register and an exclusive OR gate and is arranged to generate, as the random number signal, an M sequence having a periodicity determined by the number of digits of the shift register, and
wherein the control portion is configured to change the driving frequency F in accordance with the random number signal in a predetermined time zone at a start of a lighting operation of the discharge lamp.
